(19) United States
(12) Patent Application Publication
(10) Pub. No.: US 2023/0001425 A1
(43) Pub. Date: Jan. 5, 2023

(54) IMITATION GOLD NUGGETS FOR TESTING SLUICING MACHINES

(71) Applicant: Wayne J. Kukral, Glendale, AZ (US)

(72) Inventor: Wayne J. Kukral, Glendale, AZ (US)

(21) Appl. No.: 17/366,263

(22) Filed: Jul. 2, 2021

(51) Int. Cl. B03B 5/26; G01M 99/00

(52) U.S. Cl. CPC B03B 5/26; G01M 99/008

(57) ABSTRACT

Imitation gold nuggets for testing sluicing machines and the like, each comprising an inner body formed from a material with a specific gravity similar to gold, such as tungsten, and an outer covering formed from a material adapted to seal and protect the inner body, such that the imitation gold nuggets can be used repeatedly for testing the abilities and effectiveness of sluicing machines and the like in separating and capturing gold nuggets from ground material during operation.

### CROSS-REFERENCE TO RELATED APPLICATION

There are no related applications incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

This invention relates generally to imitation gold nuggets used for testing the abilities and effectiveness of sluicing machines and the like in separating and capturing gold nuggets from ground material during operation.

2. Description of the Related Art

Prior art material used to test the abilities and effectiveness of sluicing machines and the like in separating and capturing gold nuggets from ground material during operation have included copper or steel BB's and lead formed nuggets. The problem with BB's are that they are not as heavy as gold nuggets nor represent the size and shape effectively, therefore not a good indicator of a machines ability to separate and capture gold nuggets from ground material during operation. The downside of using lead nuggets is that they are relatively soft and break down quite quickly from the tumbling experienced within a sluice machine.

Accordingly, the present invention overcomes the disadvantages associated with the prior art, by providing imitation gold nuggets that are more similar in weight, size, and shape to real gold nuggets, and are much more durable and last much longer than the prior art materials.

### BRIEF SUMMARY OF THE INVENTION

In view of the foregoing disadvantages inherent in the known types of imitation nuggets for testing sluice machines in the prior art, the present invention provides new and improved imitation gold nuggets. As such, the general purpose of the present invention, which will be described subsequently in greater detail, is to provide new and improved imitation gold nuggets with all the advantages of the prior art and none of the disadvantages.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting

### BRIEF DESCRIPTION OF THE DRAWINGS

The figures which accompany the written portion of this specification illustrate embodiments according to the teachings of the present invention.

FIG. 1 shows a side view of the imitation gold nugget according to the preferred embodiment of the present invention.

FIG. 2 shows a cross-sectional view of the imitation gold nugget according to the preferred embodiment of the present invention of FIG. 1.

FIG. 3 shows a perspective view of imitation gold nuggets according to the preferred embodiment of the present invention of FIG. 1 being used within a sluicing machine.

FIG. 4 shows a kit including a plurality of imitation gold nuggets according to the preferred embodiment of the present invention of FIG. 1 in a package along with a sluicing machine and a user's manual.

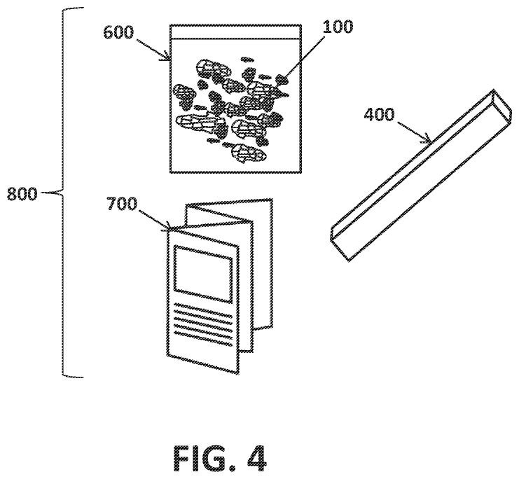

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

A sluice box is one of the oldest simple machines used by gold prospectors. It is a “separator device” that breaks layers of river sediments until gold is separated from all other materials. There are two basic types of Sluice Boxes. One uses water to wash and move the wet material through the Sluice Box while the second one uses air, gravity and shaking of the Sluice Box to get the dry material through the Sluice Box. The most common Sluice Box is the wet Sluice Box. The box is non-moving and simply uses gravity and the flow of water. As water moves through the sluice box, rocks, small, objects, sand, and gold get trapped in different layers called riffles. The device works more effectively when compared to gold panning as the act of separation is done by a machine and not by hand. Simple wet sluice boxes do not move or shake while in use. Some large scale operations may have added a separate portion to their sluice box to shake the material while being sprayed with water to clean the rocks before the material goes through the sluice box. Standard sluice boxes are usually 3 to 5 feet long, 1 to 2 feet wide, and 6 to 12 inches high, have a y-shape with a wide flare on the top and narrows down to a uniform width, are made of aluminum, wood, steel, plastic, or a combination of these materials, and have riffles that trap gold in the device. Of course, people can get creative with these things and come up with various takes on the sluice box. Some have curved shapes while others are taller than usual to work in deeper parts of a river. These differences happen based on the environment where you are prospecting for gold.

To date, tests performed by the applicant have been with a 3-inch dredge, which included a crash box on a 14-inch by 4-foot sluice box connected to a 6.5 hp Honda Motor. The sluice box includes a punch plate over a raised expanded metal on top of miner's moss on top of a deep V-mat in the crash box. The remaining bottom of the sluice box tested includes commonly used riffles with carpeting underneath and also a dream mat-dredge mat made of a Rubber/Silicon material.

In use, stream bed material, including rocks, sand, dirt, gravel, and water, is sucked up in a nozzle by a water pump and into the crash box and sluice box. Heavy materials, such as black sand, lead, and gold are captured in the sluice box while lighter materials and water wash out the lower end.

The applicant has also performed testing with a high banker with a 10-inch by 36-inch sluice box with commonly used riffles having carpeting underneath and also the dream mat made of rubber/silicon material. The stream bed material, rocks, sand, dirt, gravel, and water is shoveled or scooped into the high banker where larger rocks slide off one end while everything else flows through the grizzly bars then into the sluice box. Heavy materials, like black sand, lead, and gold are captured in the sluice box while lighter materials and water wash out the lower end.

The applicant has also performed testing with a recirculating sluice box with a 10-inch by 36-inch sluice box with the dream mat made of rubber/silicon material.

The stream bed material sizes are generally about 1/4 inch to 1/8 inch material that is shoveled or scooped into the recirculator. Heavy materials like black sand, lead, and gold are captured in the sluice box while lighter materials and water wash out the lower end where the water is recirculated.

The applicant has also performed testing with a plastic gold pan and a drywasher. Other recovery equipment used to process fine gold are gold cubes, gold screw panners, concentrating bowls, and concentrating tables. These can maybe be used with the improved nuggets if made small enough.

The applicant has also performed testing with copper BB's, steel BB's, and lead and Tungsten weights.

The applicant has found that imitation gold nuggets formed having a size ranging from 1/4 inch to 1/16 inch and a weight is from 1.5 grams to 0.5 grams work the best. And testing is most effective when forming the test nuggets in the shape of either polygonal volumes or rounded and lumpy shapes, and even flat versions to represent gold flakes.

Nuggets and Flakes should be mostly formed from Tungsten for the most appropriate weight, and possibly include magnetic material inside or outside to make it easy to remove from the sluice box after testing is completed. The outside coating/layer should be yellow-gold in color and formed from a hard material to protect the inside material.

Imitation gold test nuggets will increase a prospector's ability to recover more gold. Using test nuggets gives you quality control of your recovery equipment. And, gives the prospector the ability to measure the capture process to adjust their recovery equipment.

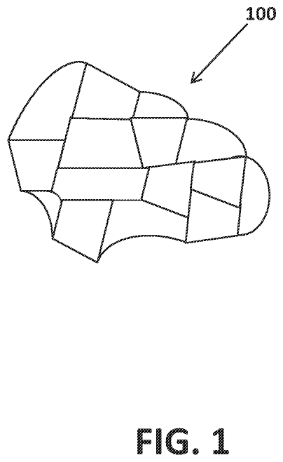

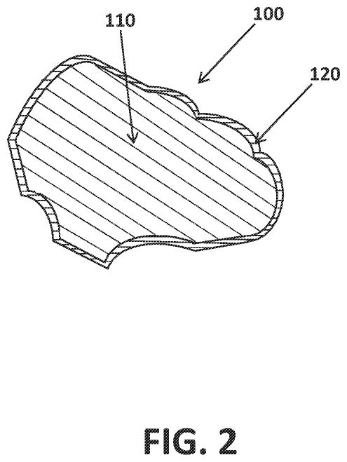

Turning now descriptively to drawing, referring to FIGS. 1-3, the present invention discloses imitation gold nuggets 100 for testing sluicing machines 400. Sluicing machines 400 usually including a water pump 410, and a sluice box 420 including a bottom panel 422 including a plurality of riffles 424 , and a shaking mechanism 430, wherein the sluicing machine is adapted to receive ground material therein from a ground material delivery mechanism 440, wash the ground material using water pumped therethrough via the water pump 410, shake the ground material passing therethrough, and separating and capturing ground material of a desired shape and size, including gold flakes and nuggets, via the plurality of riffles 424.

The imitation gold nuggets 100 each comprise an inner body 110 comprising an outer surface area, wherein the inner body is formed from a material that is in solid form at room temperature (between 67 and 78 degrees Fahrenheit) and has a specific gravity between 10 and 20; an outer covering 120 attached to a substantial portion of the outer surface area and surrounds the inner body, wherein the outer covering is formed from a material adapted to seal and protect the inner body, wherein the imitation gold nugget is adapted to be used with the sluicing machine to determine the abilities and effectiveness of the sluicing machine in separating and capturing gold nuggets from the ground material during operation.

The inner body 110 may be formed having a length between 1/4 inch and 1/16 inch; and wherein the inner body 110 is formed having a weight between 0.5 grams and 1.5 grams. The inner body 110 may be formed having a shape forming an irregular polygonal volume, such as a dodecagon. The inner body 110 may also be formed having a shape including a plurality of curved surfaces forming a lumpy nugget shape more consistent with real gold nuggets. The most effective material found to form the inner body from is tungsten, which has a specific gravity (19.6) very close to the specific gravity of gold (19.3). The outer covering 120 may be formed stainless steel, plastic, rubber, silicone, polyurethane, acrylic, fiberglass, or ceramic, and may also be formed from or include a magnetic material to make it easy to remove from the sluice box via a magnet after testing is completed.

It is important to cover the outer surface of the inner body 110 with an outer covering 120 to seal and protect the inner body in order to increase the life span of the test nuggets. Longer life span equals cost savings, and further helps keep the weights and shape of the test nuggets from deteriorating.

The imitation gold nuggets 100 can be sold individually or in a package 600. They can also be sold as a kit 800 along with a sluicing machine 400, and engineered specifically for that particular sluicing machine. Furthermore, a user's manual 700 can be included and used to describe the use of the plurality of imitation gold nuggets 100 with the sluicing machine 400 to determine the abilities and effectiveness of said sluicing machine in separating and capturing gold nuggets from the ground material during operation.

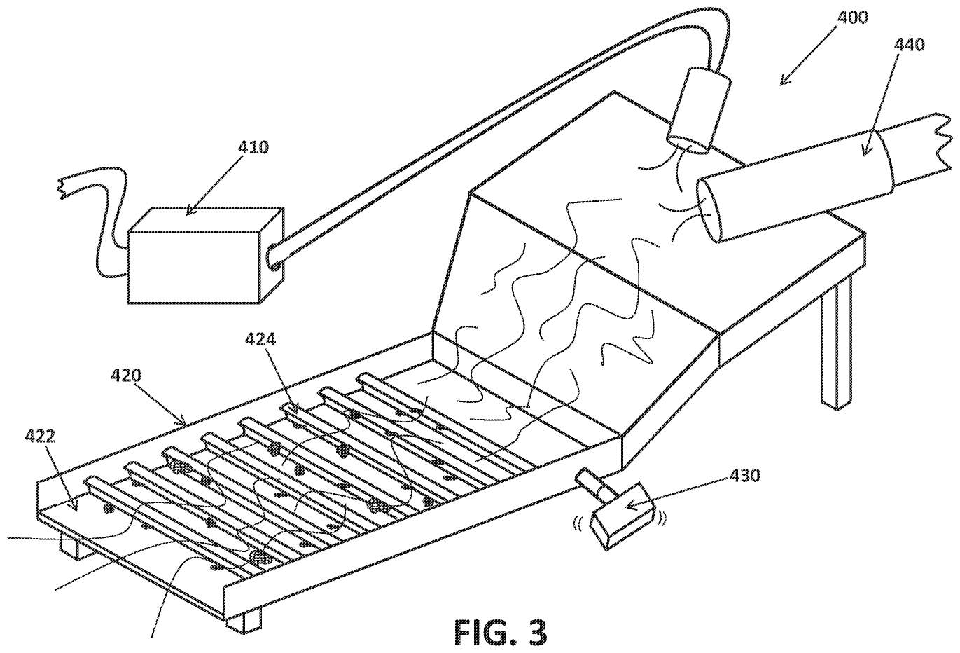

Sluicing machines 400 can be formed as described above and shown in FIG. 3, however, other configurations can be used as well, including a dredge that has water pumped thru a pressure hose to a jet flare and a suction hose that is attached to the sluice box; a dredge that has water pumped thru a pressure hose to a nozzle that is attached to a suction hose that is attached to the sluice box; and one including an air pump which pumps air into the bottom of a sluice box and blows upward thru the bottom thereof. In the first two described, water pressure creates a suction that sucks water and material thru the suction hose to the sluice box. And in the third one described, an air pump pumps air into the bottom of the sluice box and blows upward thru the bottom thereof.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. An imitation gold nugget for testing sluicing machines, comprising:
an inner body;
wherein said inner body comprises an outer surface area; and
wherein said inner body is formed from a material that is in solid form at room temperature and has a specific gravity between 10 and 20;
an outer covering;
wherein said outer covering is attached to a substantial portion of said outer surface area and surrounds said inner body; and
wherein said outer covering is formed from a material adapted to seal and protect said inner body;
wherein said imitation gold nugget is adapted to be used with sluicing machines to determine the abilities and effectiveness of said sluicing machines in separating and capturing gold nuggets from ground material during operation.

2. The imitation gold nugget of claim 1, wherein said inner body is formed having a length between 1/4 inch and 1/16 inch; and wherein said inner body is formed having a weight between 0.5 grams and 1.5 grams.

3. The imitation gold nugget of claim 1, wherein said inner body is formed having a shape forming an irregular polygonal volume.

4. The imitation gold nugget of claim 1, wherein said inner body is formed having a shape including a plurality of curved surfaces.

5. The imitation gold nugget of claim 1, wherein said inner body is formed from tungsten.

6. The imitation gold nugget of claim 1, wherein said outer covering is formed from a magnetic material.

7. The imitation gold nugget of claim 1, wherein said outer covering is formed from a material chosen from a group of materials consisting of stainless steel, plastic, rubber, silicone, polyurethane, acrylic, fiberglass, and ceramic.

8. A combination of a sluicing machine and at least one imitation gold nugget, comprising:
a sluicing machine including:
a water pump;
a sluice box including:
a bottom panel including:
a plurality of riffles; and
a shaking mechanism;
wherein said sluicing machine is adapted to receive ground material therein, wash said ground material using water pumped therethrough via said water pump, shaking said ground material that passes therethrough, and separating and capturing ground material of a desired shape and size, including gold flakes and nuggets, via said plurality of riffles; and
at least one imitation gold nugget, each comprising:
an inner body;
wherein said inner body comprises an outer surface area; and
wherein said inner body is formed from a material that is in solid form at room temperature and has a specific gravity between 10 and 20;
an outer covering;
wherein said outer covering is attached to a substantial portion of said outer surface area and surrounds said inner body; and
wherein said outer covering is formed from a material adapted to seal and protect said inner body;
wherein said imitation gold nugget is adapted to be used with said sluicing machine to determine the abilities and effectiveness of said sluicing machine in separating and capturing gold nuggets from said ground material during operation.

9. The combination of claim 8, wherein said inner body is formed having a length between 1/4 inch and 1/16 inch; and wherein said inner body is formed having a weight between 0.5 grams and 1.5 grams.

10. The combination of claim 8, wherein said inner body is formed having a shape forming an irregular polygonal volume.

11. The combination of claim 8, wherein said inner body is formed having a shape including a plurality of curved surfaces.

12. The combination of claim 8, wherein said inner body is formed from tungsten.

13. The combination of claim 8, wherein said outer covering is formed from a magnetic material.

14. The combination of claim 8, wherein said outer covering is formed from a material chosen from a group of materials consisting of stainless steel, plastic, rubber, silicone, polyurethane, acrylic, fiberglass, and ceramic.

15. A gold mining kit comprising:
a sluicing machine including:
a water pump;
a sluice box including:
a bottom panel including:
a plurality of riffles; and
a shaking mechanism;
wherein said sluicing machine is adapted to receive ground material therein, wash said ground material using water pumped therethrough via said water pump, shaking said ground material that passes therethrough, and separating and capturing ground material of a desired shape and size, including gold flakes and nuggets, via said plurality of riffles; and
a plurality of imitation gold nuggets, each comprising:
an inner body;
wherein said inner body comprises an outer surface area; and
wherein said inner body is formed from a material that is in solid form at room temperature and has a specific gravity between 10 and 20;
an outer covering;
wherein said outer covering is attached to a substantial portion of said outer surface area and surrounds said inner body; and
wherein said outer covering is formed from a material adapted to seal and protect said inner body;
wherein said imitation gold nuggets are formed having a variety of shapes and sizes;
wherein said imitation gold nuggets are adapted to be used with said sluicing machine to determine the abilities and effectiveness of said sluicing machine in separating and capturing gold nuggets from said ground material during operation; and
a user's manual;
wherein said user's manual is adapted to describe the use of said plurality of imitation gold nuggets with said sluicing machine to determine the abilities and effectiveness of said sluicing machine in separating and capturing gold nuggets from said ground material during operation.

16. The gold mining kit of claim 15, wherein said inner body is formed having a length between 1/4 inch and 1/16 inch; and wherein said inner body is formed having a weight between 0.5 grams and 1.5 grams.

17. The gold mining kit of claim 15, wherein said inner body is formed having a shape forming an irregular polygonal volume.

18. The gold mining kit of claim 15, wherein said inner body is formed from tungsten.

19. The gold mining kit of claim 15, wherein said outer covering is formed from a magnetic material.

20. The gold mining kit of claim 15, wherein said outer covering is formed from a material chosen from a group of materials consisting of stainless steel, plastic, rubber, silicone, polyurethane, acrylic, fiberglass, and ceramic.
